(19) United States
(12) Patent Application Publication
(10) Pub. No.: US 2013/0228499 A1
(43) Pub. Date: Sep. 5, 2013

(54) Vertical Filter

(71) Applicant: SUNDANCE SPAS, INC., Chino, CA (US)

(72) Inventor: Elwyn Robinson, Victorville, CA (US)

(73) Assignee: SUNDANCE SPAS, INC., Chino, CA (US)

(21) Appl. No.: 13/749,112

(22) Filed: Jan. 24, 2013

Related U.S. Application Data
(60) Provisional application No. 61/590,594, filed on Jan. 25, 2012.

(51) Int. Cl. C02F 1/00; E04H 4/12

(52) U.S. Cl. CPC C02F 1/001; E04H 4/12
USPC 210/167.1; 210/252; 210/483; 210/232

(57) ABSTRACT

A vertical filter assembly includes a top filter assembly, the top filter assembly including a primary filter; a canister in fluid communication with the top filter assembly, the canister including a canister body having a sidewall and a bottom wall that define a hollow interior of the canister; and a secondary filter positioned within the hollow interior of the canister and supported above the bottom wall of the canister.

### CROSS REFERENCE TO RELATED APPLICATION

The present application claims priority from U.S. Provisional Patent Application No. 61/590,594, filed on Jan. 25, 2012, which is incorporated herein by reference in its entirety.

### BACKGROUND OF THE INVENTION

1. Field of the Invention

The present invention relates generally to a vertical filter. More specifically, the present invention relates to a vertical filter for use in a spa tub or similar device that includes an upper cartridge-type filter removably secured to a lower canister that holds a replaceable depth filter.

2. Description of Related Art

Conventional cartridge-type filter assemblies, for both spa and pool circulation systems, typically feature a layer of pleated fabric filter material arranged in a hollow cylindrical shape around a hollow core of plastic material that features a plurality of perforations or is formed as an open grid, which provides structural support to the fabric filter material. Water passing through the circulation system flows radially into the core through the fabric filter layer, where debris is filtered from the water supply.

Such conventional filters provide only a single filtration of the water as it cycles through the circulation system. Accordingly, it can take a long time for the single filter to adequately clean the water. Further, conventional filters are not effective at filtering several different types of contaminants in the circulated water, such as oils. Thus, these contaminants will remain in the circulated water despite filtering.

### SUMMARY OF THE INVENTION

Accordingly, there is a general need for a vertical filter for a spa or pool circulation system that includes a depth load filter capable of filtering debris contaminants from circulated water in a fewer number of passes through the filter so as to reduce filtering time and is capable of filtering different water contaminants.

According to one embodiment, the present invention provides a vertical filter assembly for a spa or pool circulation system that includes a depth load filter combined with a pleated fabric depth filter. As the water is circulated through the vertical filter assembly, debris is first filtered from the circulated water by the pleated fabric depth filter and is then directed to a depth load filter connected to the pleated filter. The depth load filter is configured to remove additional debris and contaminants from the circulated water in order to quickly and efficiently clean the circulated water. The pleated fabric depth filter and the depth load filter are connected in such a manner that the pool or spa owner is able to easily remove the filter assembly, disassemble the filters, replace one or both filters, and then re-install the filters in the circulation system.

According to another embodiment, the vertical filter assembly includes a top filter assembly, the top filter assembly including a primary filter layer of pleated polyester fabric defining a top end and a bottom end, a top end member attached to the top end of the filter layer, a bottom end member defining a bottom opening attached to the bottom end of the filter layer, and a hollow core surrounded by the filter layer and in fluid communication with the filter layer via a plurality of apertures; and a canister, the canister including a canister body defining a hollow interior of the canister, a top lip defining an open top of the canister, and a bottom wall. The hollow interior of the canister is in fluid communication with the hollow core of the top filter assembly via the bottom opening in the bottom end member and the open top of the canister and is configured to contain a secondary filter. The top filter assembly is removably secured to the canister.

According to yet another embodiment, a vertical filter assembly includes a primary filter; a canister in fluid communication with the primary filter, the canister including a canister body defining a hollow interior of the canister and a bottom wall; and a depth filter positioned within the hollow interior of the canister and supported above the bottom wall of the canister, the depth filter acting as a secondary filter. The depth filter is removable from the hollow interior of the canister.

According to still another embodiment, a depth filter includes a filter body made of meltblown polypropylene, the filter body having a substantially hourglass shape defined by an upper conical half and a lower conical half joined at a narrow center portion and defining a wide top end portion and a wide bottom end portion, respectively, the filter body having an internal sidewall defining a central passageway extending through the filter body from a top end to a bottom end of the filter body; a top member attached to the top end of the filter body that closes off the central passageway at the top end of the filter body; and a bottom member attached to the bottom end of the filter body defining a flange for supporting the depth filter and a bottom opening that places the central passageway of the filter body in fluid communication with an exterior of the depth filter. The filtration characteristics of the filter body vary along a longitudinal length of the filter body.

According to a particular embodiment of the present invention, a vertical filter assembly is provided. The vertical filter assembly includes a top filter assembly, the top filter assembly including a primary filter; a canister in fluid communication with the top filter assembly, the canister including a canister body having a sidewall and a bottom wall that define a hollow interior of the canister; and a secondary filter positioned within the hollow interior of the canister and supported above the bottom wall of the canister.

According to another particular embodiment of the present invention, a water circulation system for a spa tub is provided. The circulation system includes a vertical filter assembly that includes a top filter assembly, the top filter assembly including a primary filter; a canister in fluid communication with the top filter assembly, the canister including a canister body having a sidewall and a bottom wall that define a hollow interior of the canister; and a secondary filter positioned within the hollow interior of the canister and supported above the bottom wall of the canister. The circulation system further includes a circulation pump for circulating water; at least one conduit for placing the vertical filter assembly in fluid communication with the circulation pump; at least one outlet for directing water to the spa tub; and at least one conduit for placing the circulation pump in fluid communication with the at least one outlet.

According to yet another particular embodiment of the present invention, a depth filter is provided. The depth filter includes a filter body made of meltblown polypropylene. The filter body has a substantially hourglass shape. Filtration characteristics of the filter body vary along a longitudinal length of the filter body.

Further details and advantages of the invention will become clear upon reading the following detailed description in conjunction with the accompanying drawing figures, wherein like parts are designated with like reference numerals throughout.

### BRIEF DESCRIPTION OF THE DRAWINGS

FIG. 1 depicts a perspective view of a vertical filter assembly according to an embodiment of the present invention;

FIG. 2 depicts a side view of the vertical filter assembly;

FIG. 3 depicts an exploded side view of the vertical filter assembly;

FIG. 4 depicts a perspective view of a top filter assembly of the vertical filter assembly;

FIG. 5 depicts a side view of the top filter assembly;

FIG. 6 depicts a cross-sectional side view of the top filter assembly;

FIG. 7 depicts a top view of the top filter assembly;

FIG. 8 depicts a bottom view of the top filter assembly;

FIG. 9 depicts a perspective view of a canister of the vertical filter assembly;

FIG. 10 depicts a side view of the canister;

FIG. 11 depicts a cross-sectional side view of the canister taken along line A-A in FIG. 10;

FIG. 12 depicts a top view of the canister;

FIG. 13 depicts a bottom view of the canister;

FIG. 14 depicts a perspective view of a lock pin of the vertical filter assembly;

FIG. 15 depicts a perspective view of a depth filter of the vertical filter assembly;

FIG. 16 depicts a side view of the depth filter;

FIG. 17 depicts a top view of the depth filter;

FIG. 18 depicts a bottom view of the depth filter;

FIG. 19 depicts a schematic of a water circulation system for a spa tub incorporating the vertical filter assembly according to an embodiment of the present invention;

FIG. 20 depicts a pressure v. flow chart illustrating the pressure drop across individual components of the vertical filter assembly and combinations thereof;

FIG. 21 depicts a pressure v. flow chart illustrating the pressure drop across individual components of the vertical filter assembly and combinations thereof;

FIG. 22 depicts a turbidity chart comparing a prior art filter and a depth filter according to an embodiment of the present invention;

FIG. 23 depicts a pressure v. flow chart illustrating pressure drop across individual components of the vertical filter assembly; and

FIG. 24 depicts a side view of a cylindrical depth filter according to another embodiment of the present invention.

### DESCRIPTION OF THE INVENTION

For purposes of the description hereinafter, spatial orientation terms, if used, shall relate to the referenced embodiment as it is oriented in the accompanying drawing figures or otherwise described in the following detailed description. However, it is to be understood that the embodiments described hereinafter may assume many alternative variations and embodiments. It is also to be understood that the specific devices illustrated in the accompanying drawing figures and described herein are simply exemplary and should not be considered as limiting.

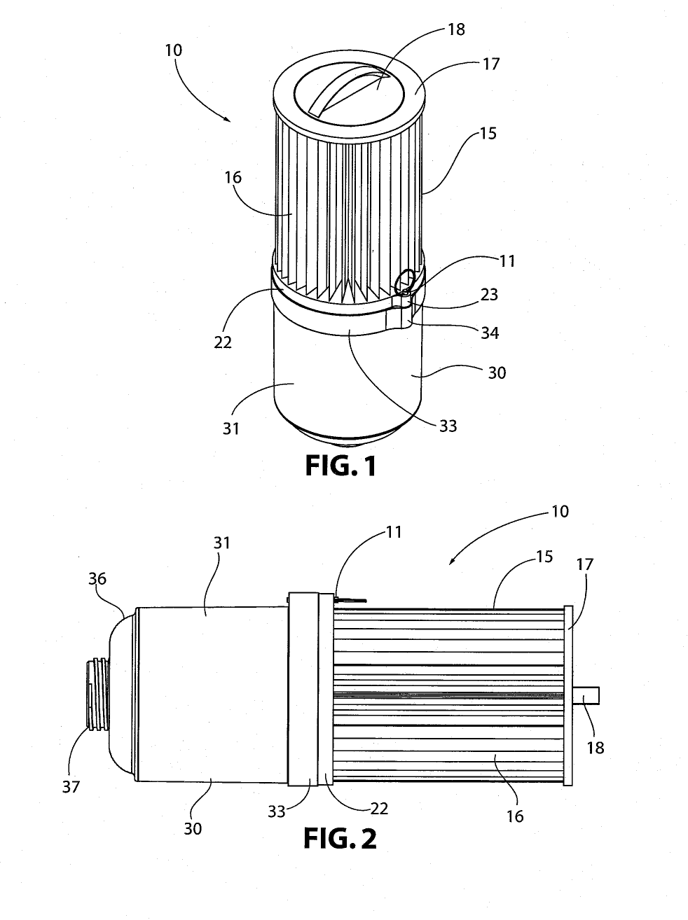

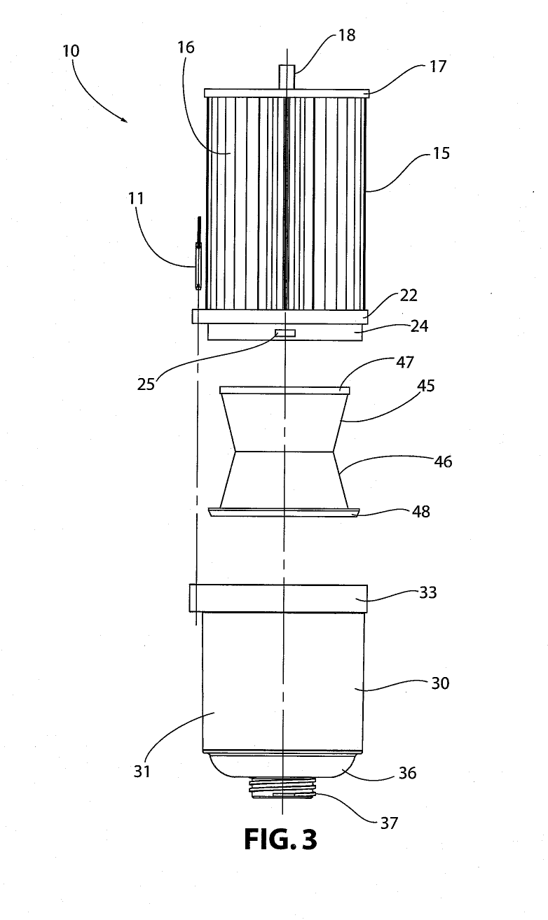

With reference to FIGS. 1-3, a vertical filter assembly 10 is shown in accordance with an embodiment of the present invention. The vertical filter assembly 10 includes a top filter assembly 15, a canister 30, a lock pin 11 for securing the top filter assembly 15 to the canister 30, and a depth filter 45 that is housed inside the interior of the canister 30.

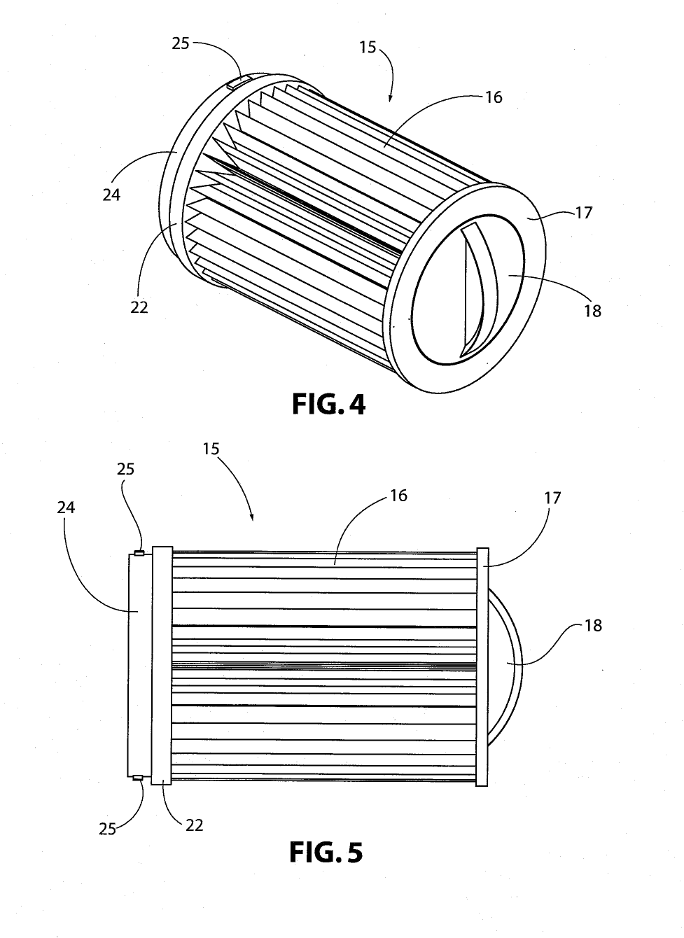

With reference to FIGS. 4-8, the top filter assembly 15 includes a primary filter, which includes a filter layer 16 made of a pleated polyester fabric arranged in a hollow cylindrical shape. The fabric of the filter layer 16 may be formed as such, or may be formed from a sheet of fabric material, which is pleated and subsequently joined at the edges to form a longitudinal joint, according to techniques known to those of ordinary skill in the art. A plurality of bands may be provided about the outer circumference of the filter layer for retaining the filter layer in a cylindrical shape.

The filter layer 16 may be made from any fabric known to be suitable to those having ordinary skill in the art. For instance, the outer filter layer may be 3 oz. REEMAY® fabric, manufactured by Fiberweb plc.

As stated above, the filter layer 16 is arranged in a hollow cylindrical shape defining a top end and a bottom end. A top end member 17 is disposed on the top end of the filter layer 16 and retains the filter layer 16 in its cylindrical shape. To that end, the top end member 17 may include an annular groove (not shown) in a surface thereof that is capable of receiving the first end of the filter layer 16. The top end member 17 also includes a removable cap 18 that is removably secured to the top end member 17 in an interlocking engagement between a portion of the cap 18 and a recess formed in the top end member 17. The cap 18 may be used to cover an opening through the top end member 17. A dispenser 19 for bromine or other water treating chemical may be secured to the cap 18 such that the dispenser 19 is removed from the top filter assembly 15 with the cap 18.

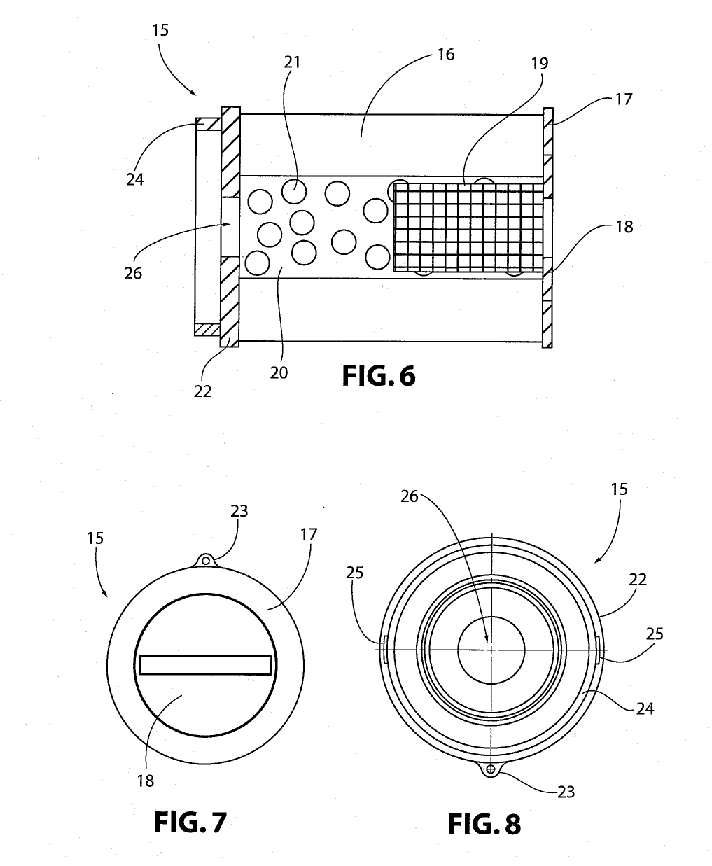

As shown in FIG. 6, the top filter assembly 15 includes a hollow cylindrical core 20 for supporting the filter layer 16, which includes a sidewall with a plurality of perforations 21. The perforations 21 place the hollow interior of the core 20 in fluid communication with the exterior surface of the sidewall. The dispenser 19 extends from the underside of the cap 18 through the opening in the top end member 17 and into the interior of the hollow cylindrical core 20.

A bottom end member 22 is disposed on the bottom end of the filter layer 16 and retains the filter layer 16 in its cylindrical shape. To that end, the bottom end member 22 may also include an annular groove (not shown) in a surface thereof that is capable of receiving the bottom end of the filter layer 16. The bottom end member 22 has an annular shape defining a bottom opening 26 with an upper portion and a connection portion 24 depending from the upper portion. A first protrusion 23 radially extends from the bottom end member 22 and includes a hole sized to receive the lock pin 11 therein. At least two tabs 25 extend radially outward from the connection portion 24. The tabs 25 are provided for removably securing the top filter assembly 15 to the canister 30, as will be described in further detail below.

Depending upon the model of spa and circumstances of use, the top filter assembly 15 may be of any suitable size. In particular, the top filter assembly 15 may have a longitudinal length of 6.5″, 8.5″, or 12″ (165 mm, 216 mm, or 305 mm) extending from the surface of the top member 17 to the bottom surface of the bottom end member 22 above the connection portion 24.

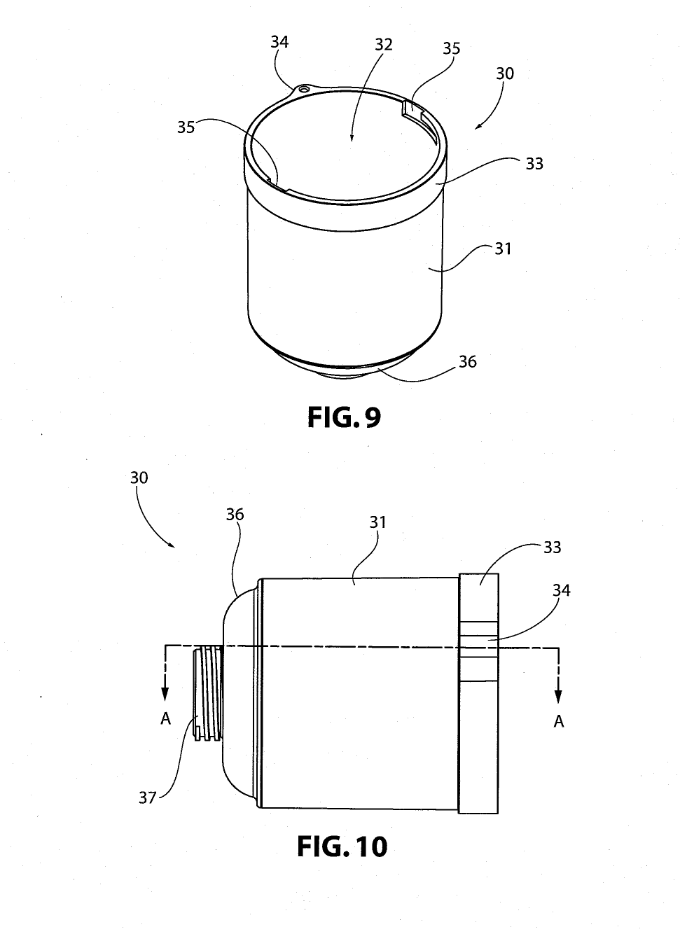

With reference to FIGS. 9-13, the canister 30 includes a canister body 31 formed from a sidewall and a bottom wall 36 that define a hollow interior 32. The hollow interior 32 is in fluid communication with the hollow core 20 of the top filter assembly 15 via the bottom opening 26 of the bottom end member 22 and an open top end of the canister 30. The open top end of the canister 30 is defined by a top lip 33 having a diameter that is slightly larger than the diameter of the sidewall of the canister body 31. The top lip 33 is configured to receive and engage the connection portion 24 of the bottom end member 22 of the top filter assembly 10 therein. A second protrusion 34 radially extends from the top lip 33 and includes a hole sized to receive the lock pin 11 therein. At least two interior grooves 35 are defined in an inside surface of the top lip 33. The grooves 35 are L-shaped and are configured to receive and releasably engage the tabs 25 on the connection portion 24 of the bottom end member 22 of the top filter assembly 15. The connection portion 24 of the bottom end member 22 of the top filter assembly 15 is received within the top lip 33 of the canister 30 such that the top filter assembly 15 is removably secured to the canister 30 by the releasable engagement between the tabs 25 and the L-shaped grooves 35. This configuration allows for a user to remove the filter assembly from a circulation system, disassemble the top filter assembly 15 from the canister 30, and replace the top filter assembly 15 and/or the depth filter 45.

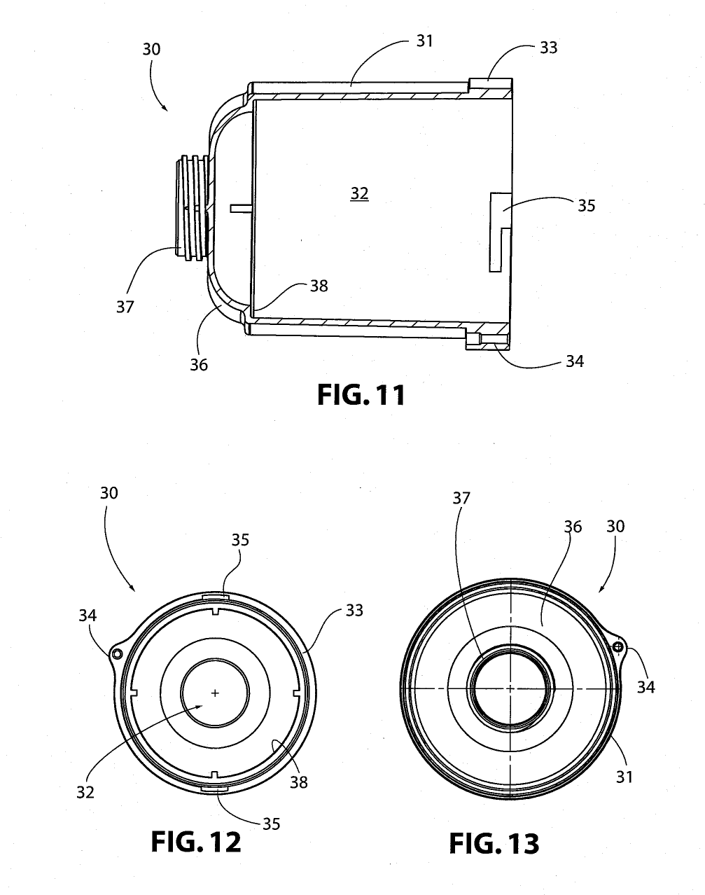

As shown in FIGS. 11 and 12, the bottom wall 36 of the canister 30 has an annular bowl shape defining an opening at the bottom end of the canister 30. An internal flange 38 is formed in the canister 30 at the junction between the sidewall of the canister body 31 and the bottom wall 36. The internal flange 38 supports the depth filter 45 within the hollow interior 32 of the canister 30. A threaded coupling 37 extends outwardly from the bottom wall 36 and is in fluid communication with the opening in the bottom wall 36 so that water can pass from the hollow interior 32 of the canister 30 to a water circulation system 200 of the spa. It is to be appreciated that the canister 30 is configured to attach to different sizes of filters in the top filter assembly 15 so long as the filters have a compatible diameter and attachment mechanism. In particular, the canister 30 is compatible with a top filter assembly 15 having a longitudinal length of 6.5″, 8.5″, or 12″ (165 mm, 216 mm, or 305 mm), as discussed above.

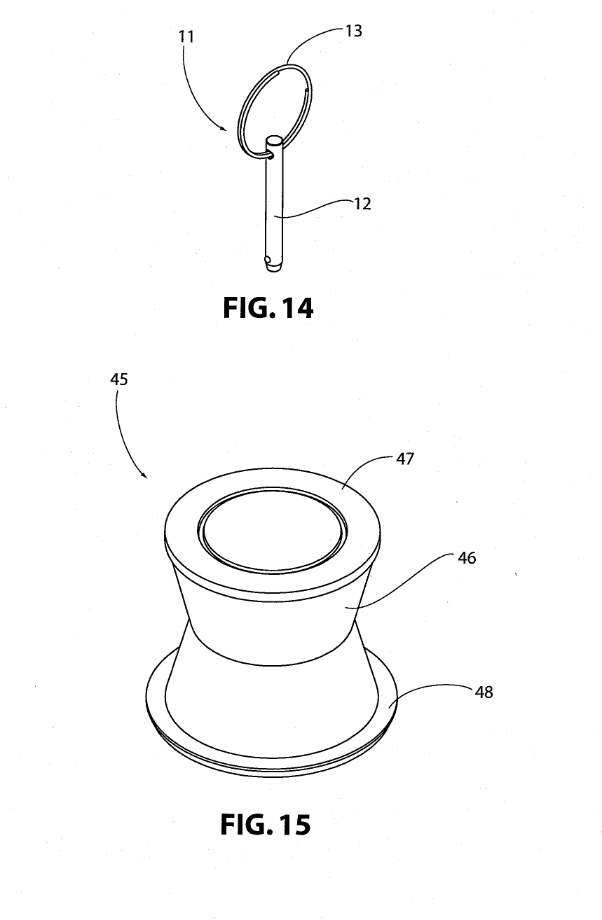

With reference to FIG. 14, the filter assembly 10 also includes a lock pin 11 for securing the top filter assembly 15 to the canister 30. The lock pin 11 includes a pin body 12 and a key ring 13 for handling the lock pin 11. As shown in FIGS. 1-3 and 8-12, the first protrusion 23 and the second protrusion 34 are arranged with respect to the tabs 25 and the L-shaped grooves 35 such that the holes of the first protrusion 23 and the second protrusion 34 are aligned when the tabs 25 are fully engaged with the L-shaped grooves 35. As discussed above, the holes of the first protrusion 23 and the second protrusion 34 are configured to receive the lock pin 11. When aligned, the holes receive the lock pin 11 to secure the engagement between the tabs 25 and the L-shaped grooves 35, and prevent removal of the top filter assembly 15 from the canister 30. The configuration of the tabs 25 on the top filter assembly 15 cooperating with the grooves 35 in the canister 30 with relative rotation of the top filter assembly 15 and the canister 30 being prevented by the lock pin 11 allows for a user to remove the filter assembly from a circulation system, disassemble the top filter assembly 15 from the canister 30, and replace the top filter assembly 15 and/or the depth filter 45. It is to be appreciated that the top filter assembly 15 may be secured to the canister 30 by any method known to be suitable to those having ordinary skill in the art that allows for quick and simple disassembly of the vertical filter assembly 10, replacement of the filters 15, 45, and reassembly.

With reference to FIGS. 15-18, the depth filter 45 acts as a secondary filter for the vertical filter assembly 10 and has a substantially hourglass shape and a filter body 46 made from meltblown polypropylene throughout and having an internal sidewall, which defines a central passageway 49 extending through the filter body 46 from a top end to a bottom end of the filter body 46. The depth filter 45 also includes a top member 47 that closes the top end of the central passageway 49 of the filter body 46 and a bottom member 48 having an annular shape, which defines a bottom opening to place the central passageway 49 of the filter body 46 in fluid communication with the bottom wall 36 and the threaded coupling portion 37 of the canister 30. The bottom member 48 also forms a flange for supporting the depth filter 45 on the internal flange 38 of the canister 30.

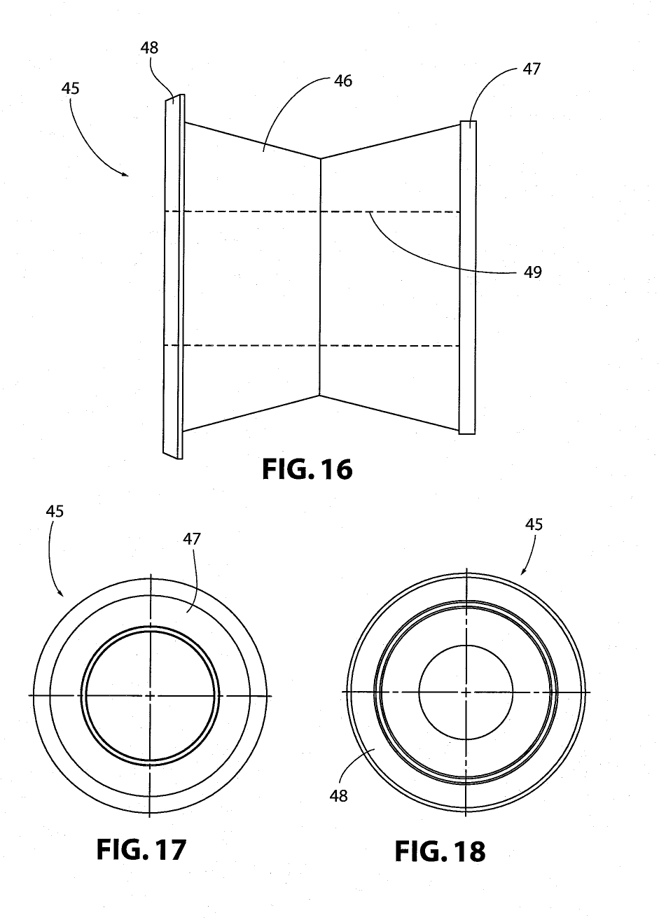

As shown in FIGS. 15 and 16, the filter body 46 has a substantially hourglass shape of upper and lower conical halves joined at a narrow center portion. This shape allows for filtration differentiation, i.e., the filtration characteristics of the filter body 46 will change across the length of the filter body 46 to provide different degrees of filtration across the length of the filter body 46. In particular, the narrow center portion will filter only larger particles while the wide top and bottom portions of the filter body 46 will filter smaller particles. Accordingly, during use, the filter body 46 will clog first in the center portion and subsequently outwardly towards the top and bottom ends of the filter body 46. It is to be appreciated that the depth filter 45 may be formed of any shape and material known to be suitable to those having ordinary skill in the art. For instance, the filter body 46 of the depth filter 45 may have a cylindrical shape. Further, it is to be appreciated that the depth filter 45 may be replaced with any type of filter known to be suitable to those having ordinary skill in the art that can be placed within the canister 30. For instance, the canister 30 can be filled with a suitable particulate or aggregate filter media that is retained within the canister 30 and forms the depth filter 45.

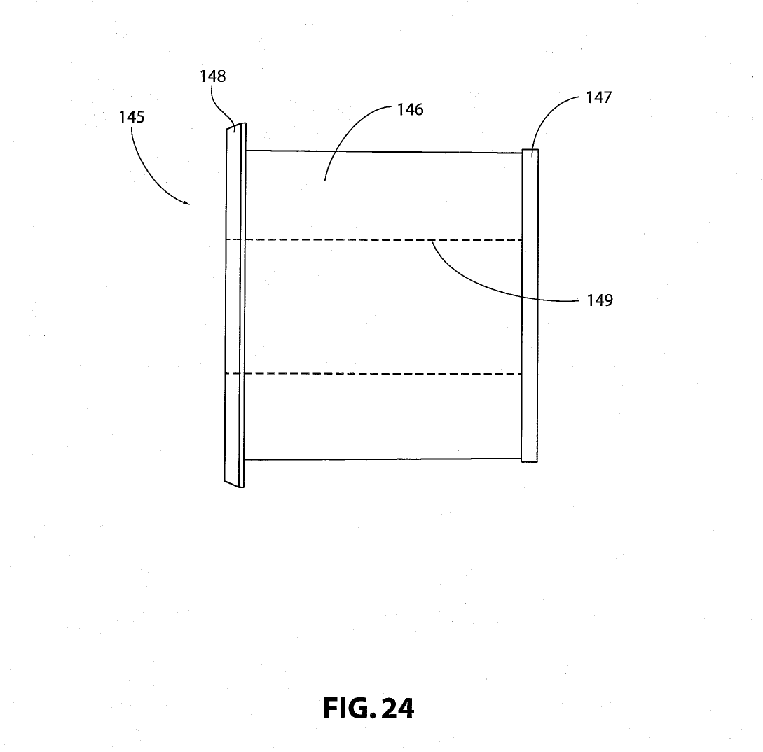

With reference to FIG. 24, according to an alternative embodiment of the present invention, the depth filter 145 includes a filter body 146 having a cylindrical, rather than hourglass, shape. The filter body 146 is made from meltblown polypropylene throughout and has an internal sidewall, which defines a central passageway 149 extending through the filter body 146 from a top end to a bottom end of the filter body 146. The depth filter 145 also includes a top member 147 that closes the top end of the central passageway 149 of the filter body 146 and a bottom member 148 having an annular shape, which defines a bottom opening to place the central passageway 149 of the filter body 146 in fluid communication with the bottom wall 36 and the threaded coupling portion 37 of the canister 30. The bottom member 148 also forms a flange for supporting the depth filter 145 on the internal flange 38 of the canister 30.

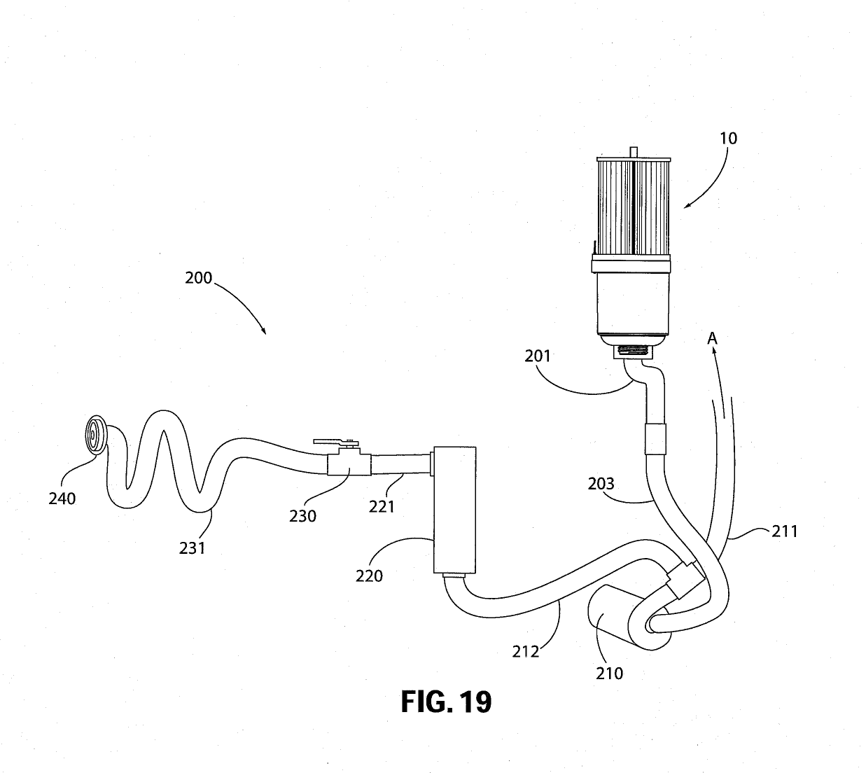

With reference to FIGS. 1-3, the filter assembly 10 is assembled by positioning the depth filter 45 within the canister 30 such that the bottom member 48 of the depth filter 45 rests on the internal flange 38 of the canister 30. When a pump 210 for the circulation system 200, discussed below with reference to FIG. 19, is activated, the suction from the pump 210 will pull the depth filter 45 down into the canister 30 toward the bottom wall 36 of the canister 30 such that the bottom member 48 of the depth filter 45 sealingly engages the bottom wall 36 of the canister 30 and water is drawn through the filter body 46 to be filtered.

The top filter assembly 15 is then positioned on top of the canister 30 while the tabs 25 on the connection portion 24 of the bottom end member 22 of the top filter assembly 15 are aligned and engaged with the vertical portion of the L-shaped grooves 35 formed in the interior surface of the top lip 33 of the canister 30, such that the bottom end member 22 rests upon the top lip 33 and the connection portion 24 of the bottom end member 22 extends into open top end of the canister 30. The top filter assembly 15 is then rotated clockwise about its longitudinal axis relative to the canister 30 such that the tabs 25 on the connection portion 24 of the bottom end member 22 of the top filter assembly 15 engage with the horizontal portions of the L-shaped grooves 35 such that the top filter assembly 15 is vertically secured to the canister 30. The protrusion 23 on the bottom end member 22 is positioned relative to the tabs 25 and the protrusion 34 on the top lip 33 of the canister 30 is positioned relative to the grooves 35 such that pin holes in the protrusions 23, 34 are aligned. The body 12 of the lock pin 11 is then inserted through the pin holes in both protrusions 23, 34 to secure the top filter assembly 15 and the canister 30 from being rotated relative to each other and disengaging the tabs 25 from the grooves 35.

During use of the filter assembly 10, water will flow radially through the pleated filter 16 of the top filter assembly 15, which filters particles and debris from the circulating water, and into the hollow core 20 of the top filter assembly 15 via the perforations 21 in the hollow core 20. The water then flows downward through hollow core 20 of the top filter assembly 15 and the bottom opening 26 in the bottom end member 22 into the hollow interior 32 of the canister 30. Once within the hollow interior 32 of the canister 30, the water will then flow radially through the filter material of the filter body 46 of the depth filter 45, which further filters particles and debris from the circulating water, and into the central passageway 49 of the filter body 46. Water flows out of the central passageway 49 via the opening in the bottom member 48 of the depth filter 45 and then out of the canister 30 via the threaded coupling 37 into the circulation system 200 of the spa. Accordingly, the filter assembly 10 provides for dual filtering of the water circulating through the circulation system 200. The filter layer 16 of the top filter assembly 15 acts as a primary filter for removing larger debris and particles from the water. The depth filter 45 acts as a secondary filter for removing fine particles and contaminants from the water.

The filter assembly 10 is removable from the spa tub and may be disassembled by removing the lock pin 11 and rotating the top filter assembly 15 counterclockwise and lifted away to disengage the tabs 25 from the grooves 35. The hollow interior 32 of the canister 30 can then be accessed for removal and replacement of the depth filter 45. The filter layer 16 of the top filter assembly 15 may be sprayed with water to remove any debris trapped thereon. Further, because the depth filter 45 is removable from the canister 30, the filter body 46 may be separately cleaned and disinfected, thus prolonging the operational lifetime of the depth filter 45. According to an embodiment of the present invention, the top filter assembly 15 has an operational lifetime of 18-24 months and the depth filter 45 has an operational lifetime of 3-4 months.

With reference to FIG. 19, a schematic view of a water circulation system 200 of a spa tub is shown. The water flowing from the basin of the tub first passes into a filter chamber, which contains the filter assembly 10. Due to pressure within the filter chamber, water is then caused to flow into the filter assembly 10 in a radial path through the filter layer 16 of the top filter assembly 15, where larger debris and particles are filtered from the water and subsequently through the depth filter 45, where fine particles and contaminants are additionally filtered from the water. A filter outlet conduit 201 is threadably coupled to the threaded coupling portion 37 at the bottom end of the canister 30 of the filter assembly 10. The filter outlet conduit 201 is coupled to the threaded coupling portion 37 such that the filter assembly 10 is removable from the circulation system 200 and the filter chamber for cleaning, maintenance, and replacement.

Filtered water flows through the outlet conduit 201, which is joined to a pump inlet conduit 203 and to a circulation pump 210 via the pump inlet conduit 203. The circulation pump 210 is responsible for controlling the circulation of water into the basin via both the jet nozzles and waterfalls, or similar features. Filtered water directed to the basin and passing through one or more waterfalls or similar features is pumped by the circulation pump 210 through a pump outlet conduit 211 directly to the waterfall, as indicated by arrow A. Filtered water directed to the basin and passing through the jet nozzles is first directed to a water heater 220 via a pump outlet conduit 212, branching away from the pump outlet conduit 211. The heater 220 operates to heat the filtered water to a desired temperature before the water is directed through the jet nozzles. Filtered, heated water is then directed through a conduit 221 to a flow switch 230 for controlling the flow of water into the basin via the jet nozzles. After passing through the flow switch 230, the water passes through a conduit 231 to one or more outlets 240, which are coupled to the jet nozzles, which direct the water into the basin, according to techniques known to those of ordinary skill in the art. It is to be appreciated that while the filter assembly 10 has been described as being incorporated into a water circulation system 200 for a spa tub, the filter assembly 10 could be adapted to filter water in other circulation systems, for instance, the circulation system for a pool.

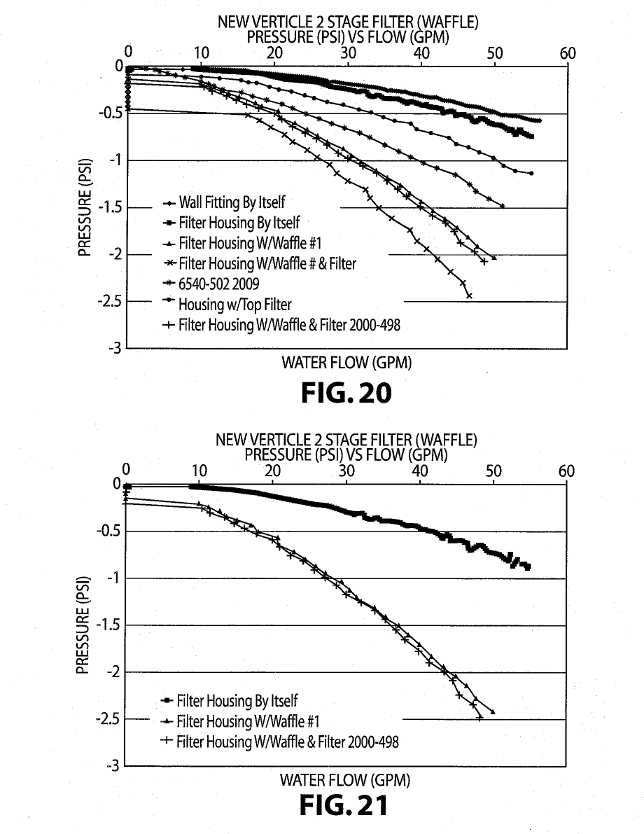

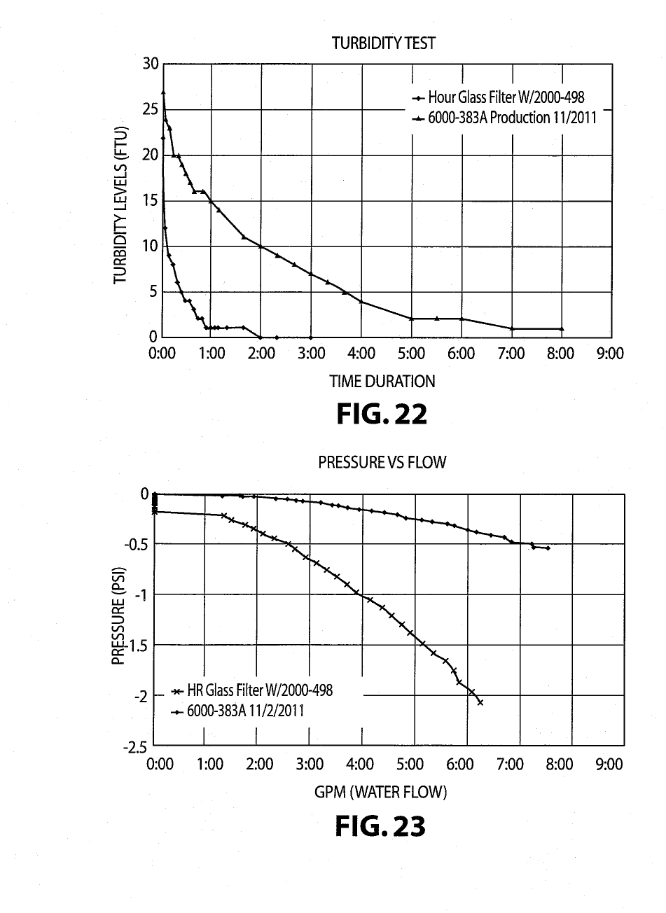

FIGS. 20-23 illustrate the performance of the filter assembly 10 and various components thereof with respect to pressure v. flow, i.e., the pressure drop created by the components of the filter assembly 10 both together and alone, and turbidity. During a turbidity test, the filter assembly 10, according to the above embodiment of the present invention, was left running while 30 grams of silica sand were dumped into 40 gallons of water. The filter was then operated with water running through the filter assembly until the filter became loaded with sand. During the test, the turbidity levels of the water were checked every five to ten minutes. The measured turbidity level of the water over time as the water was continually filtered by the filter assembly is shown in FIG. 22 by the line having diamond-shaped data points. This test demonstrates the effectiveness and operability of the filter, as the filter should steadily continue to reduce turbidity in the water until the reading reaches zero. As can be appreciated from FIGS. 20-23, the combination of the depth filter 45 and top filter assembly 15 is able to clean debris and contaminants from circulated water much more quickly than a pleated fabric depth filter acting alone.

While specific embodiments of the invention have been described in detail, it will be appreciated by those skilled in the art that various modifications and alternatives to those details could be developed in light of the overall teachings of the disclosure. The presently preferred embodiments described herein are meant to be illustrative only, and not limiting as to the scope of the invention, which is to be given the full breadth of the appended claims and any and all equivalents thereof.

The invention claimed is:

1. A vertical filter assembly, comprising:
a top filter assembly, the top filter assembly including a primary filter;
a canister in fluid communication with the top filter assembly, the canister including a canister body having a sidewall and a bottom wall that define a hollow interior of the canister; and
a secondary filter positioned within the hollow interior of the canister and supported above the bottom wall of the canister.

2. The vertical filter assembly according to claim 1, wherein the secondary filter is removable from the hollow interior of the canister.

3. The vertical filter assembly according to claim 1, wherein the primary filter includes a filter layer of pleated fabric defining a top end and a bottom end, and the top filter assembly further includes a top end member attached to the top end of the filter layer, a bottom end member defining a bottom opening attached to the bottom end of the filter layer, and a hollow core surrounded by the filter layer and in fluid communication with the filter layer via a plurality of apertures, and
wherein the hollow interior of the canister is in fluid communication with the hollow core of the top filter assembly via the bottom opening in the bottom end member.

4. The vertical filter assembly according to claim 3, wherein the pleated fabric of the filter layer comprises polyester.

5. The vertical filter assembly according to claim 3, wherein the top end member of the top filter assembly includes a removable cap that covers an opening in the top filter assembly and the top filter assembly further includes a chemical dispenser disposed within the hollow core and secured to the removable cap.

6. The vertical filter assembly according to claim 3, wherein the bottom end member of the top filter assembly includes a connection portion and the canister includes a top lip defining an open top of the canister, the top lip of the canister being configured to engage the connection portion of the bottom end member of the top filter assembly to removably secure the top filter assembly to the canister.

7. The vertical filter assembly according to claim 6, wherein
the top lip of the canister is configured to receive the connection portion of the bottom end member of the top filter assembly therein,
the connection portion of the bottom end member of the top filter assembly includes at least two tabs radially extending therefrom and the top lip of the canister includes an interior surface having at least two L-shaped grooves defined therein, and
the L-shaped grooves are configured to receive and releasably engage the tabs on the connection portion of the bottom end member of the top filter assembly when the connection portion of the bottom end member of the top filter assembly is received within the top lip of the canister, such that the top filter assembly is removably secured to the canister by the releasable engagement between the tabs and the L-shaped grooves.

8. The vertical filter assembly according to claim 7, wherein
the vertical filter assembly further includes a lock pin,
the bottom end member of the top filter assembly includes a first protrusion radially extending therefrom, the first protrusion having a hole defined therein,
the top lip of the canister includes a second protrusion radially extending therefrom, the second protrusion having a hole defined therein,
the first protrusion and the second protrusion are arranged with respect to the tabs and the L-shaped grooves such that the holes of the first protrusion and the second protrusion are aligned when the tabs are fully engaged with the L-shaped grooves, and
the holes of the first protrusion and the second protrusion are configured to receive the lock pin when aligned to secure the engagement between the tabs and the L-shaped grooves and prevent removal of the top filter assembly from the canister.

9. The vertical filter assembly according to claim 1, wherein the top filter assembly has a longitudinal length of 6.5″, 8.5″, or 12″ (165 mm, 216 mm, or 305 mm).

10. The vertical filter assembly according to claim 1, wherein the top filter assembly is removably secured to the canister.

11. The vertical filter assembly according to claim 1, wherein the secondary filter comprises a depth filter removably positioned within the hollow interior of the canister.

12. The vertical filter assembly according to claim 11, wherein the depth filter comprises meltblown polypropylene.

13. The vertical filter assembly according to claim 11, wherein a filter body of the depth filter has a cylindrical shape.

14. The vertical filter assembly according to claim 1, wherein the bottom wall of the canister has an annular bowl shape with a bottom opening defined therein, an internal flange for supporting the secondary filter thereon, and a threaded coupling extending outwardly therefrom.

15. The vertical filter assembly according to claim 1, wherein the top filter assembly and the canister are arranged such that fluid filtered by the primary filter is subsequently directed to the hollow interior of the canister to be filtered by the secondary filter.

16. A water circulation system for a spa tub, comprising:
a vertical filter assembly, the vertical filter assembly comprising:
a top filter assembly, the top filter assembly including a primary filter;
a canister in fluid communication with the top filter assembly, the canister including a canister body having a sidewall and a bottom wall that define a hollow interior of the canister; and
a secondary filter positioned within the hollow interior of the canister and supported above the bottom wall of the canister;
a circulation pump for circulating water;
at least one conduit for placing the vertical filter assembly in fluid communication with the circulation pump;
at least one outlet for directing water to the spa tub; and
at least one conduit for placing the circulation pump in fluid communication with the at least one outlet.

17. A depth filter, comprising:
a filter body made of meltblown polypropylene, the filter body having a substantially hourglass shape,
wherein filtration characteristics of the filter body vary along a longitudinal length of the filter body.

18. The depth filter according to claim 17, wherein the substantially hourglass shape of the filter body is defined by an upper conical half and a lower conical half joined at a narrow center portion and defining a wide top end portion and a wide bottom end portion, respectively.

19. The depth filter according to claim 17, wherein the filter body has an internal sidewall defining a central passageway extending through the filter body from a top end to a bottom end of the filter body.

20. The depth filter according to claim 19, further comprising:
a top member attached to the top end of the filter body that closes the central passageway at the top end of the filter body; and
a bottom member attached to the bottom end of the filter body defining a flange for supporting the depth filter and a bottom opening that places the central passageway of the filter body in fluid communication with an exterior of the depth filter.
